(19) United States
(12) Patent Application Publication
(10) Pub. No.: US 2012/0102477 A1
(43) Pub. Date: Apr. 26, 2012

(54) FIRMWARE UPDATE METHOD AND APPARATUS FOR A MOBILE DEVICE

(75) Inventors: Hotae KIM, Seoul (KR); Sungkwan Cho, Suwon-si (KR); Joo Hark Park, Suwon-si (KR)

(73) Assignee: Samsung Electronics Co., Ltd., Suwon-si (KR)

(21) Appl. No.: 13/275,917

(22) Filed: Oct. 18, 2011

(30) Foreign Application Priority Data
Oct. 21, 2010 (KR) 10-2010-0102809

(51) Int. Cl. G06F 9/44; G06F 1/24

(52) U.S. Cl. 717/169

(57) ABSTRACT

A method and apparatus for updating firmware of a mobile device based on the result of verification of integrities of a plurality of update files is provided. The firmware update method includes downloading a plurality of update files corresponding to the firmware and checksums corresponding to each of the update files in a user data storage region upon detecting a firmware update event; verifying whether each of the update files is valid; and updating the firmware using at least one valid update file from among the plurality of update files.

### PRIORITY

This application claims priority to an application filed in the Korean Intellectual Property Office on Oct. 21, 2010 and assigned Ser. No. 2010-0102809, the entire content of which is incorporated herein by reference.

### BACKGROUND OF THE INVENTION

1. Field of the Invention

The present invention relates generally to a firmware update method and apparatus of a mobile device and, in particular, to a method and apparatus for updating firmware of a mobile device based on a result of verification of respective integrities of a plurality of update files.

2. Description of the Related Art

Due in part to the rapid advance of information and semiconductor technologies, there has been a phenomenal growth in the use and popularity of mobile devices. Recently, many mobile devices, in addition to providing dedicated services, have become multifunctional devices that support converged functions and services. A mobile communication terminal, for example, may incorporate a variety of supplementary functions such as a Television (TV) function, (e.g., Digital Multimedia Broadcasting (DMB) and/or Digital Video Broadcasting (DVB)), an audio playback function (e.g. Motion Picture Experts' Group (MPEG) Audio Layer-3 (MP3)), a camera function, an Internet access function, a dictionary function, and a search function, in addition to basic voice communication and messaging functions.

A mobile device typically operates under the control of a firmware. The firmware includes programs stored in a Read Only Memory (ROM) in the form of core software that doesn't require any change in data or information, and the firmware is used as though it were a part of hardware itself. New versions of such firmware are continuously developed in order to secure program stabilization and fix bugs that may have unexpectedly appeared in a previous version of the firmware, and such new firmware may be installed after an initial installation of original firmware.

Once a new version of the firmware is developed, the previous version of the firmware is updated to the new version. The firmware update of a mobile device can be performed in various ways via a wired or wireless link. Recently, wireless firmware update has become a prevailing process for updating firmware. Firmware Over The Air (FOTA) is one such wireless firmware update method. FOTA is a technology for updating the firmware by applying a delta file generated from a difference between two versions of the firmware. In particular, the mobile device generates the delta file and updates the previous version of the firmware by modifying a part corresponding to the delta file.

In order to perform the firmware update, the mobile device may include an update agent, which includes a delta file storage region. The conventional firmware update procedure includes downloading the delta file of the mobile device in the delta file storage region and asking the user whether to update the firmware.

There may be situations where a firmware has not been updated for such a long period of time that multiple updated versions of the firmware may exist. In such a situation where multiple updated versions of the firmware exist, the conventional firmware update method performs a firmware update by downloading and updating the multiple updated versions of the firmware, in sequence, due to a limited storage space for the delta file. This conventional firmware update method asks the user whether to perform the firmware update whenever attempting firmware update with each of the different versions of the firmware, resulting in user's inconvenience. Therefore, there is a need for a firmware update method for efficiently updating the firmware, especially when multiple firmware update files exist.

### SUMMARY OF THE INVENTION

An aspect of the present invention provides a mobile device supporting firmware update with multiple update files and a firmware update method thereof. Another aspect of the present invention provides a mobile device and firmware update method thereof for checking integrities of a plurality of update files in advance and performing a firmware update according to the integrity check result. Another aspect of the present invention provides a mobile device and firmware update method thereof for checking integrities of a plurality of update files downloaded in firmware update process and performing the firmware update with at least one of the update files according to a result of the integrity check. Another aspect of the present invention provides a mobile device and firmware update method thereof for improving usability and user convenience by providing the environment optimized for firmware update.

In accordance with an aspect of the present invention, a method for updating firmware of a mobile device is provided. The method includes downloading a plurality of update files corresponding to the firmware and checksums corresponding to each of the update files in a user data storage region upon detecting a firmware update event; verifying whether each of the update files is valid; and updating the firmware using at least one valid update file from among the plurality of update.

In accordance with another aspect of the present invention, a mobile device is provided. The mobile device includes a communication module for receiving a plurality of update files and checksums corresponding to each of the update files from a Firmware Over The Air (FOTA) server; a storage unit for storing the update files; and a control unit for verifying whether each of the update files is valid, updating the firmware using at least one valid update file from among the plurality of update files.

In accordance with another aspect of the preset invention, a non-transitory computer-readable storage medium that stores instructions executable by at least one processor to perform a method is provided. The method includes downloading a plurality of update files corresponding to the firmware and checksums corresponding to each of the update files in a user data storage region upon detecting a firmware update event; verifying whether each of the update files is valid; and updating the firmware using at least one valid update file from among the plurality of update files.

### BRIEF DESCRIPTION OF THE DRAWINGS

The above and other objects, features and advantages of the present invention will become more apparent from the following detailed description when taken in conjunction with the accompanying drawings, in which:

FIG. 1 is a schematic diagram illustrating a firmware update system according to an embodiment of the present invention;

FIG. 2 is a block diagram illustrating a configuration of a mobile device according to an embodiment of the present invention; and

FIG. 3 is a flowchart illustrating a firmware update method of a mobile device according to an embodiment of the present invention.

### DETAILED DESCRIPTION OF EMBODIMENTS OF THE PRESENT INVENTION

Embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention. However, is should be noted that the present invention is not limited to the descriptions made herein but can be implemented in various other embodiments.

Embodiments of the present invention include a firmware update method and apparatus of a mobile device. The firmware update method and apparatus verifies integrities of multiple update files in advance and performs firmware update based on an integrity verification result. This firmware update method and apparatus may prevent a firmware update process from freezing due to abnormal update files, and thus avoids potentially serious system problems.

An apparatus according to an embodiment of the present invention may utilize an update file, an update agent, and a user data storage region, which are described as follows.

The update file is generated according to a difference between an old version and a new version of the firmware of the mobile device, and can include data corresponding to the difference and information indicating the address to which data corresponding to the new version of the firmware is installed. The update file may be referred to as a “delta file” or a “differential file”.

The update agent is a program responsible for updating the firmware of the mobile device. Typically, the update agent is provided in the form of a module and includes a delta file storage region for storing the update file.

The user data storage region stores various data generated through use of the mobile device. In particular, the user data storage region can store a plurality of update files downloaded from a Firmware Over The Air (FOTA) server and transfer the available firmware update files to the delta file storage region.

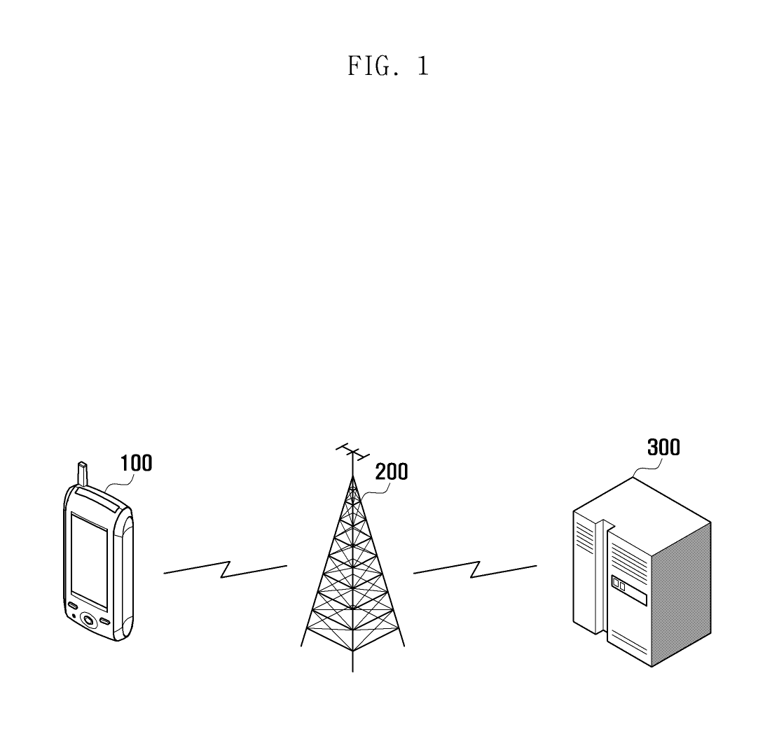

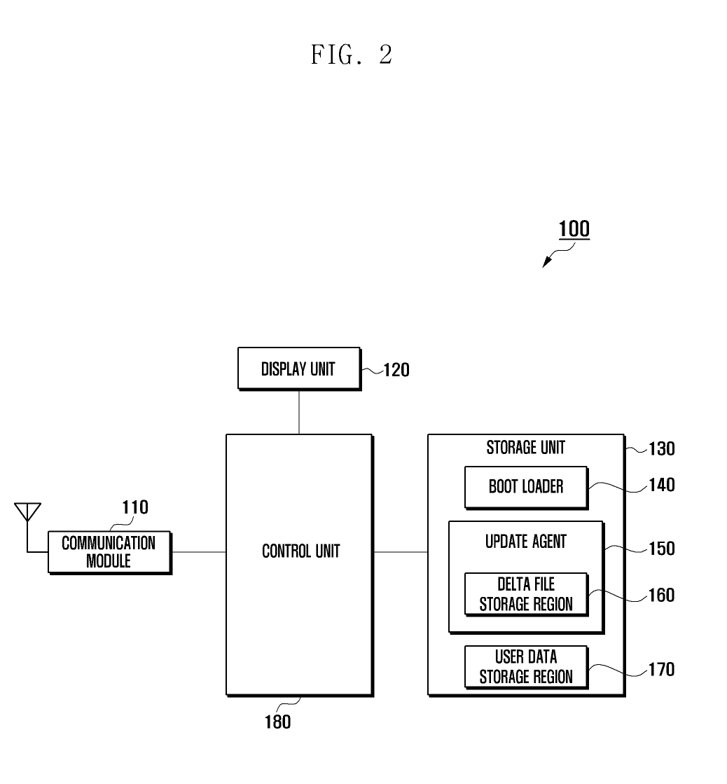

FIG. 1 is a schematic diagram illustrating a firmware update system according to an embodiment of the present invention. FIG. 2 is a block diagram illustrating a configuration of a mobile device according to an embodiment of the present invention.

Referring to FIGS. 1 and 2, the firmware update system includes a mobile device 100, a network 200, and a FOTA server 300.

The mobile device 100 is a device that supports firmware update and includes an update agent 150 responsible for the firmware update, a boot loader 140, and a control unit 180 responsible for controlling overall operations of the mobile device 100. The mobile device 100 can download a plurality of update files from the FOTA server 300 to update the installed firmware. Particularly, the mobile device 100 temporarily stores the update files in a user data storage region 170 to verify the integrities of the update files.

If the integrities of all the update files are verified, the mobile device 100 transfers the update files to a delta file storage region 160 and the performs the firmware update procedure with the update files. If at least one of the update files is invalid, the mobile device 100 transfers the update files, except for any invalid update files, to the delta file storage region 160. According to an embodiment of the present invention, the mobile device 100 verifies the integrity of the update file using the checksum provided by the FOTA server 300. The firmware update operation of the mobile device 100 is described in more detail hereinbelow.

The checksum method is one of the error detection methods used for checking the integrity of data and checking errors in the update files, according to an embodiment of the present invention. In the present example, the FOTA server 300 transmits the update files along with the related checksum such that the mobile device 100 compares the received checksum with the checksum of each update file. However, the mobile device verifies the integrity of the update files by performing error correction on each update file with the checksum received from the FOTA server 300.

The network 200 includes a wireless base station installed by a service provider for providing mobile communication services via the communication channel established between the mobile device 100 and the FOTA server 300. The network 200 can deliver a plurality of update files and a checksum associated with the update files provided by the FOTA server 300 to the mobile device 100.

The FOTA server 300 provides the firmware update service to the mobile device 100. The FOTA server 300 can be a server of the mobile carrier and/or the manufacturer of the mobile device 100. The FOTA server 300 is responsible for comparing the old and new versions of the firmware with each other to check the difference and generating the update file with the difference. When a new version of the firmware is issued, the FOTA server 300 generates an update file reflecting the differences between the new version and the old version of the firmware, and transmits the update file to the mobile device 100. The FOTA server 300 can also retrieve at least one update file differing from the current version of the firmware installed in the mobile device 100 and transmit the retrieved update file to the mobile device 100 in response to the firmware update request transmitted by the mobile device 100 connected to the FOTA server 300. When the update file is normal, the FOTA server 300 can transmit the update file along with a checksum, in accordance with an embodiment of the present invention.

As shown in FIG. 2, the mobile device 100 includes a communication module 110, a display unit 120, a storage unit 130, and a control unit 180. Although not depicted in the drawing, the mobile device 100 can further include at least one of an audio processing unit including a microphone and a speaker, a digital broadcast module for payback of digital broadcast such as Digital Multimedia Broadcasting (DMB) and Digital Video Broadcasting (DVB), a camera module for taking still/motion pictures, a Bluetooth module for executing Bluetooth communication, an internet access module for supporting internet access, a touchpad for supporting touch-based input, an input unit for receiving physical key input, a display unit for displaying video data associated with the operations of the mobile device 100, a battery for supplying power to the internal function blocks, etc. Herein, “Bluetooth” refers to methods and devices compliant with the BLUETOOTH® specification.

The communication module 110 supports cellular communication service and Internet Protocol (IP) communication service (e.g., Wireless Fidelity (Wi-Fi) service on a Wireless Local Area Network (WLAN)). The communication module 110 establishes a communication channel with the FOTA server 300 via the network 200 and processing data communication with the FOTA server 300. Particularly, according to an embodiment of the present invention, the communication module 110 can receive several update files and their corresponding checksums provided by the FOTA server 300 via the network 200. The communication module 110 also can transmit a firmware update request to the FOTA server 300 under the control of the control unit 180.

The display unit 120 displays a home screen and application execution screens of the applications running on the mobile device 100. For example, the display unit 120 is capable of displaying the execution screens of the applications related to messaging, email, Internet access, multimedia playback, search, communication, electronic book (e-book), still/motion picture capture, still/motion picture playback, Television (TV) playback (e.g., DMB and DVB playback), music player (e.g., MP3 playback), widget, memo, and game functions. Although the display unit 120 may be implemented with a Liquid Crystal Display (LCD), the display unit 120 may also be implemented with one of Light Emitting Diode (LED), Organic LED (OLED), and Active Matrix OLED (AMOLED) displays, for example. According to an embodiment of the present invention, the display unit 120 can be configured to provide an update file download status screen and a firmware update status screen. The firmware update status can be presented in the form of a text or an image. Particularly according to an embodiment of the present invention, the display unit 120 can display the firmware update result. The firmware update result can be provided in the form of a popup window.

The storage unit 130 stores various programs and data to be executed and processed in the mobile device 100 and includes at least one of non-volatile and volatile memories. The non-volatile memory can be any of a Read Only Memory (ROM) and flash memory, and the volatile memory can be a Random Access Memory (RAM). The storage unit 130 may temporarily or permanently store the Operating System (OS) of the mobile device 100, programs and data related to the display operation of the display unit 120, programs and data related to the input operation on the display unit 120, and programs and data related to the firmware update of the mobile device 100.

The storage unit 130 includes a boot loader 140, an update agent 150, a delta storage region 160, and a user data storage region 170.

The boot loader 140 is a program for booting up the mobile device 100. The boot loader 140 checks system flags during a booting process, operates the update agent 150 when a firmware update flag is set, and completes boot-up of the Operation System (OS) when no firmware update flag is set.

The update agent is responsible for the firmware update function. The update agent 150 is a program for updating the firmware of the mobile device 100 with the update file (e.g., delta file) and includes a delta file storage region 160 for storing update files.

When update file is stored in the delta storage region 160, the update agent 150 is activated by the boot loader 140. The delta file storage region 160 can be designed to in consideration of the storage capacity for storing a plurality of update files for firmware update.

The user data storage region 170 stores various data generated according to the use of the mobile device. More specifically, the user data storage region 170 temporarily stores a plurality of update files in the firmware update process.

The control unit 180 controls overall operations of the mobile device 100. More specifically, the control unit 180 controls operations related to the firmware update function. For example, the control unit 180 checks and detects events related to the firmware update. A firmware update event can occur manually in response to a user request or can occur automatically when a predetermined condition is fulfilled (e.g., periodically updating according to a predetermined time).

If a firmware update event is detected, the control unit 180 establishes a connection to the FOTA server 300. In the connection setup process, the control unit 180 checks whether any update files for updating the firmware of the mobile device 100 exist. When a plurality of firmware update files are found, the control unit 180 checks the storage space of the storage unit 130 (particularly, the user data region 170). If it is determined that there is sufficient storage space for the firmware update files, the control unit 180 downloads the update files and stores the update files in the user data storage region 170 of the storage unit 130. If there is not enough storage space, the control unit 180 controls the display unit 120 to display an alarm message in the form of a popup window.

The control unit 180 verifies the checksums of each individual update file stored in the user data storage region 170. The checksum verification is performed by comparing the checksum (first checksum) of each update file stored in the user data storage region 170 with the checksum (second checksum) provided in association with the update files downloaded from the FOTA server 300.

If the first checksum matches the second checksum, the control unit 180 transfers the corresponding update files to the delta file storage region 160. Next, the control unit 180 resets the system flag for performing the firmware update operation in system reboot and then performs reboot of the mobile device 100. In the rebooting process, the control unit 180 can load the boot loader 140 to control the system booting. At this time, the control unit 180 checks the system flag to determine whether the firmware update is necessary. Upon determining that the firmware update is necessary, the control unit 180 resets the mobile device 100 and activates the update agent 150 to update the firmware. After completing the firmware update, the control unit 180 deletes the update files from the delta file storage region 160, sets the system back to an original state, and then reboots the mobile device 100.

Otherwise if the first checksum does not match the second checksum, the control unit 180 determines that there is an error in at least one of the update files. In this case, the control unit 180 transmits error information regarding the update files to the FOTA server 300. The control unit 180 also can control the display unit 120 to display an indication of the firmware update failure caused by update file error in the form of a popup window. At this time, the control unit 180 manually or automatically performs a partial firmware update with the normal update files according to the user settings.

As aforementioned, the FOTA server 300 provides the mobile device 100 with the checksum (second checksum) related to the update file such that the control unit 180 can check the integrity of the update file based on the checksum (first checksum) of the downloaded update file and the second checksum in advance. Accordingly, the control unit 180 can avoid serious error problems caused by abnormal termination of the firmware update process due to the error of a specific file.

Detailed control operations of the control unit 180 are described herein below in the section explaining the firmware update control method. In addition, the control unit 180 is responsible for controlling operations related other typical functions of the mobile device 100. For example, the control unit 180 controls execution of an application and display of the data related to the executed application. The control unit 180 can also be configured to receive signals input through various input gestures made on a touchscreen-enabled input interface and control execution of the operations corresponding to the input signals. The control unit 180 can also control the booting process according to the powering-on/off of the mobile device 100 during a normal operation mode.

Meanwhile, the configuration of the mobile device 100 depicted in FIG. 2 can be applied to any of portable devices manufactured in various forms, including bar type, folder type, slide type, swing type, and flip type devices. The mobile terminal 100 can be any of devices including an information communication device, a multimedia device, and equivalents having installed direct push applications. For example, the mobile terminal 100 can be any of a mobile communication terminal, a tablet Personal Computer (PC), a smartphone, a Portable Multimedia Player (PMP), a digital broadcast player, a Personal Digital Assistant (PDA), a portable game console, etc., which support communication in compliance with one of various communication protocols.

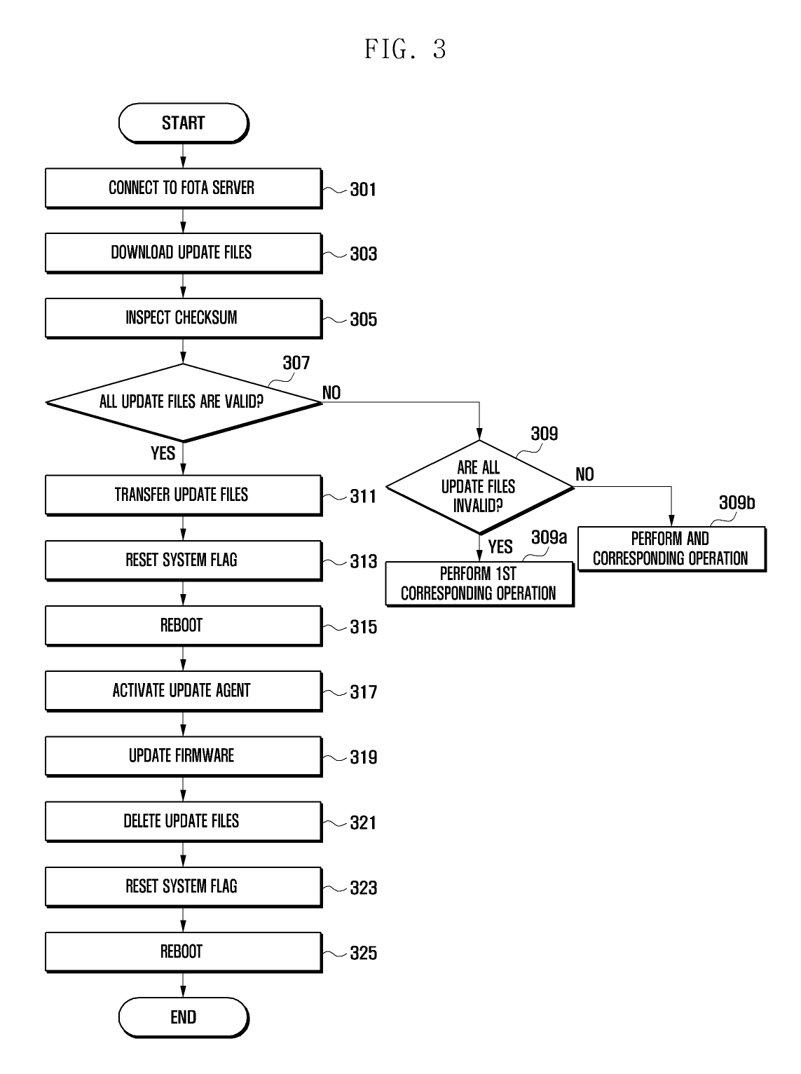

FIG. 3 is a flowchart illustrating a firmware update method of a mobile device according to an embodiment of the present invention.

Referring to FIG. 3, in step 301, the mobile device 100 connects to the FOTA server. For example, the control unit 180 of the mobile device 100 controls the communication module 110 to establish a connection with the FOTA server 300 upon detecting a firmware update event.

Next, in step 303, the mobile terminal 100 downloads at least one update file from the FOTA server 300. In this embodiment of the present invention, it is assumed that a plurality of update files is downloaded. The control unit 180 stores the plurality of update files in the user data storage region 170.

In step 305, the mobile device 100 inspects the checksums of the downloaded update files, and determines whether the validities of all of the store update files in step 307, and determines whether all of the update files are invalid in step 309. According to an embodiment of the present invention, the FOTA server 300 provides checksums related to the update files such that the control unit 180 downloads the update files along with respective checksums. The control unit 180 verifies the checksums of the stored update files using the checksum (i.e., a second checksum) downloaded with the update files. The control unit 180 also verifies the integrities of all of the downloaded update files through the checksum inspection. More specifically, the control unit 180 compares the first checksum with the second checksum in order to determine whether there are any update files having a non-matching first and second checksums.

Upon determining that all of the update files are abnormal, in step 309, the mobile device 100 performs a first corresponding operation in step 309a. For example, the control unit 180 can forcibly terminate the firmware update process according to the user setting. The control unit 180 can also notify a user and/or the FOTA server 300 of the error found in at least one update file. More specifically, the control unit 180 compares the first and second checksums with each other and, if at least one of the update files has a checksum error, notifies a user and/or the FOTA server 300 of the information on the error. According to an embodiment of the present invention, the error information notification includes transmitting the error information having the status information indicating the error to the FOTA server 300 along with the information on the update file. Notifying the user of the error information also includes outputting the error information notification on the display unit 120 in the form of a popup window.

However, upon a determination that only some of the update files are abnormal, the control unit 180 can perform a second corresponding operation in step 309b. More specifically, the control unit 180 may automatically perform the firmware update with the at least one normal update file in series according to the user settings. More specifically, the control unit 180 can perform a partial firmware update with the normal update files. At this time, the control unit 180 transfers only the normal update files to the delta file storage region 160 and performs the partial firmware update using the update files transferred to the delta file storage region 160. The control unit can continue or terminate the firmware update process with the normal update files according to the user input provided in response to display of the popup window. As stated hereinabove, once the partial firmware update has completed, the control unit 180 deletes the normal update files stored in the delta file storage region 160 as well as the abnormal update files remained in the user data storage region 170.

Upon determining that all of the update files are normal (i.e. the checksums of all the update files are valid) at step 307, the mobile device 100 transfers the update files to the delta file storage region 160, in step 311. In step 313, the mobile device 100 resets the system flag and reboots in step 315. More specifically, the control unit 180 of the mobile device 100 moves the plurality of update files stored in the user data storage region 170 to the delta file storage region 160 for firmware update. Then, the control unit 180 resets the system flag such that the firmware update process is performed at next booting process, i.e., the control unit 180 can reset the system flag with the information instructing firmware update and then reboot the mobile device 100.

In the rebooting process, the mobile device 100 activates the update agent, in step 317. For example, the boot loader 140, which is executed first in the booting process of the mobile device 100, checks the system flag. More specifically, the boot loader 140 checks the system flag to determine whether to perform firmware update. As aforementioned, if the system flag is set to a value indicating the firmware update, the update agent is loaded. For example, the update agent can be loaded on the control unit 180.

In step 319, the mobile device performs a firmware update with the update files stored in the delta file storage region 160. For example, the control unit 180 can perform the firmware update operation by means of the update agent 150. The update agent 150 is responsible for updating the firmware of the mobile device.

Once the firmware update has been completed, the corresponding update files are deleted from the delta file storage region 160, in step 321. The mobile device 100 resets the system flag back to the original value in step 323 and reboots again in step 325. For example, the control unit 180 performs the firmware update with the plural update files stored in the delta storage region 160 through the update agent 150 and, if the firmware update is completed, the control unit 180 deletes the update files from the delta file storage region 160. In order to process the booting process normally in the reboot process after the completion of the firmware update, the control unit 180 resets the system flag back to the original value (i.e. the normal booting information). In particular, the control unit 180 of the mobile device 100 reboots the mobile device according to recovered system flag information.

Accordingly, in the rebooting process after completion of the system firmware update, the control unit 180 checks the system flag and continues booting the mobile device 100 in the normal booting process according to the reset value of the system flag.

Although not depicted in FIG. 3, according to another embodiment of the present invention, the control unit 180 checks the storage space in the download process for downloading a plurality of update files. For example, the mobile device 100 may check the capacity of the user data storage region 170 to determine whether there is enough storage space in the process of connecting to the FOTA server 300 and checks the update files for the firmware update. If there is not sufficient storage space in the user data storage region 170, the mobile device 100 can download only some of the update files to update the firmware. When there is not enough storage space in the user data storage region 170, the mobile device 100 may notify the user of the shortage, and subsequently continue or terminate the firmware update according to a user selection. Upon a receiving a selection to continue the firmware update, the mobile device 100 inspects the checksums of the portion of the update files downloaded and performs a firmware update in the manner described above with reference to FIG. 3.

Although not depicted in FIG. 3, the mobile device 100 can output information indicating a result of the firmware update after the firmware update and the system reboot. As aforementioned, if only a partial firmware update has been performed, the mobile device 100 can provide the information indicating the update files that have not yet been applied for the firmware update.

Firmware update methods according to embodiments of the present invention can be recorded in a computer-readable storage medium in the form of program commands executed by means of various types of computer means. The computer-readable storage medium can store the program commands, data files, and data structures independently or in combination.

As described above, a firmware update method and apparatus of a mobile device according to embodiments of the present invention may reduce time required to perform and update and improve update stability. The firmware update method and apparatus may also prevent an update process from being terminated abnormally due to an error in one or more of a plurality of update files.

The firmware update method and apparatus may also avoid serious problems caused by abnormal termination of the firmware update process.

The firmware update method and apparatus according to embodiments of the present invention may also verify the integrity of the checksum of each of a plurality of update files before starting the firmware update process and notify, if an erroneous update file is detected, the FOTA server and/or user of the erroneous update file, resulting in avoidance of abnormal termination of firmware update service. The firmware update method and apparatus may also update the firmware of a mobile device with the update files each having a respective verified integrity, while excluding the erroneous update files.

The firmware update method and apparatus according to embodiments of the present invention may be applied to all types of mobile devices. Furthermore, s firmware update method and apparatus according to an embodiment of the present invention may update firmware of a mobile device efficiently, thereby improving usability, user convenience, and competitiveness of the mobile device.

Computer-readable media according to embodiments of the present invention may include program commands, data files, data structures, etc. separately or in combination. The computer-readable media may include magnetic media such as a hard disk, a floppy disk and magnetic tape, optical media such as a Compact Disk Read-Only Memory (CD-ROM) and a Digital Versatile Disk (DVD), magneto-optical media such as floptical disk, and hardware devices such as a ROM, a Random-Access Memory (RAM), a flash memory, etc., particularly implemented to store and execute program commands. Also, the media may be transmission media such as optical or metal lines, waveguides, etc., including carriers for delivering signals indicating program commands, data structures, etc. The program commands may be machine language codes produced by a compiler and/or high-level language codes that can be executed by computers using an interpreter, etc. In order to perform the operations of the present invention, the hardware devices may be implemented to operate as at least one software module, and vice versa.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for updating firmware of a mobile device, comprising:
downloading a plurality of update files corresponding to the firmware and checksums corresponding to each of the update files in a user data storage region upon detecting a firmware update event;
verifying whether each of the update files is valid; and
updating the firmware using at least one valid update file from among the plurality of update files.

2. The method of claim 1, wherein verifying whether each of the update files is valid includes determining whether each of the plurality of update files is valid, based on the checksums, is the checksums being provided by a Firmware Over The Air (FOTA) server to which the mobile device is connected.

3. The method of claim 2, wherein verifying whether each of the update files is valid includes comparing the checksum of each of the update files with a corresponding checksum provided by the FOTA server.

4. The method of claim 3, wherein updating the firmware includes:
executing, when all of the update files are valid, a first-type firmware update using all of the update files; and
executing, when at least one of the update files is invalid, a second-type firmware update using only the valid update files from among the update files.

5. The method of claim 4, wherein executing the first-type firmware update includes transferring all of the update files from the user data storage region to a delta file storage region.

6. The method of claim 4, wherein executing the second-type firmware update includes:
transferring, from the user data storage region, only the valid update files from among the update files to a delta file storage region; and
performing a partial firmware update using only the valid update files from among the update files.

7. The method of claim 3, further comprising:
checking a storage space of the user data storage region;
downloading and storing, when the storage space is at least equal to a space necessary for storing the update files, the update files in the user data storage region; and
downloading and storing, when the storage space is less than the space necessary for storing the update files, only a selection of the update files in the user data storage region.

8. The method of claim 1, wherein updating the firmware comprises:
transferring the at least one update file from the user data storage region to a delta file storage region;
resetting a system flag to a value corresponding to a firmware update instruction;
rebooting the mobile device;
updating the firmware with the update files stored in the delta file storage region by referencing the system flag during the rebooting process.

9. The method of claim 8, further comprising rebooting the mobile device with the system flag reset to a value indicating a normal booting instruction after completion of the firmware update.

10. The method of claim 1, further comprising:
rebooting the mobile device upon completion of the firmware update;
outputting, after the rebooting, information indicating a result of the firmware update,
wherein the result information includes information indicating any of the update files that have not yet been used for the firmware update.

11. A mobile device comprising:
a communication module for receiving a plurality of update files and checksums corresponding to each of the update files from a Firmware Over The Air (FOTA) server;
a storage unit for storing the update files; and
a control unit for verifying whether each of the update files is valid, updating the firmware using at least one valid update file from among the plurality of update files.

12. The mobile device of claim 11, wherein the storage unit includes:
a boot loader for checking a system flag during a booting process of the mobile terminal, activating an update agent when the system flag indicates a firmware update, and boots up an operating system when the system flag is set to a normal value;
an update agent including a delta file storage region for storing the update files and controlling the firmware update; and
a user data storage region for storing the update files and transferring the update files to the delta file storage region during the firmware update.

13. The mobile device of claim 12, wherein the control unit downloads and stores, when storage space of the user data storage region is at least equal to a space necessary for storing the update files, the update files downloaded in the user data storage region, and
wherein the control unit downloads and stores, when the storage space is less than the space necessary for storing the update files, only a selection of the update files in the user data storage region.

14. The mobile device of claim 13, wherein the control unit transfers the update files from the user data storage region to a delta file storage region, resets a system flag to a value corresponding to a firmware update instruction, reboots the mobile device, and updates the firmware with the update files stored in the delta file storage region by referencing the system flag in the rebooting process.

15. The mobile device of claim 13, wherein when at least one of the update files is invalid the control unit transfers, to the delta file storage region, only the valid update files from the user data storage region and performs a partial firmware update using the valid update files.

16. A non-transitory computer-readable storage medium that stores instructions executable by at least one processor to perform a method comprising:
downloading a plurality of update files corresponding to the firmware and checksums corresponding to each of the update files in a user data storage region upon detecting a firmware update event;
verifying whether each of the update files is valid; and
updating the firmware using at least one valid update file from among the plurality of update files.
